(19) United States
(12) Patent Application Publication
(10) Pub. No.: US 2014/0282000 A1
(43) Pub. Date: Sep. 18, 2014

(54) ANIMATED CHARACTER CONVERSATION GENERATOR

(71) Applicant: Tawfiq AlMaghlouth, Ras Tanura (SA)

(72) Inventor: Tawfiq AlMaghlouth, Ras Tanura (SA)

(21) Appl. No.: 13/838,822

(22) Filed: Mar. 15, 2013

(51) Int. Cl. G06F 3/0484; G06F 3/16

(52) U.S. Cl. CPC G06F 3/0484; G06F 3/165
USPC 715/723

(57) ABSTRACT

An animated character conversation generator configured to enable a user to rapidly generate and edit multimedia presentations having animated characters that move in time based on predefined expressions in synchronization with recorded audio and without requiring any rendering at the time of generating the presentation, in order to create a conversation between at least two animated characters. Embodiments enable rapid upload to video, movie, file sharing and social network sites or any other remote location for viewing by other users.

### BACKGROUND OF THE INVENTION

1. Field of the Invention

One or more embodiments of the invention are related to the field of animated graphics and multimedia applications. More particularly, but not by way of limitation, one or more embodiments of the invention enable an animated character conversation generator configured to enable a user to rapidly generate animated movies with predefined animated characters that move in time based on predefined expressions in synchronization with recorded audio to create a conversation between at least two animated characters. Embodiments enable the generation of animated movies without modeling or rendering. Embodiments enable rapid upload to video, movie, file sharing and social network sites or any other remote location for viewing by other users.

2. Description of the Related Art

There are many types of animated characters, such as cartoon characters that appear relatively flat and which may be drawn on cells traditionally or with computer programs, clay animated characters which are physically manipulated and moved for each shot, or computer animated characters that are computer generated and that imply a depth to the human viewer for example through ray tracing. These animated characters are created during movie production to create complex animated films that are viewed by millions of users.

Current solutions for generating computer animated videos with computer generated characters, for example that are animated, or that otherwise move, require not only modeling characters to have certain shapes and movement capabilities, but also massive amounts of computer processing time for rendering characters or otherwise ray tracing characters to move according to the script of the movie. The amount of time required to model and animate characters is large and presents a large barrier to entry for artists or other non-computer expert users to create their own animated movies.

In terms of the amount of video created annually, the largest amount of video created annually is standard video as opposed to computer-generated video. Standard video or movies are widely recorded with a diverse array of devices, including standalone video recorders, cell phones and tablet computers. In contrast, the number of animated films with realistically generated characters for example is much lower than standard video. This in part is based on the types of tools and associated learning curve required to generate animated videos.

Once a movie is created, whether standard or animated, it may generally be shared with others in a variety of ways. One such manner in which video is shared includes uploading the video to a video sharing website or file sharing website, for example using a standalone web application. Commonly known video sharing websites include YOUTUBE®. However, there are currently no known solutions that enable extremely rapid generation of animated movies with nearly instantaneous upload of the animated movie to a website for mass viewing.

For at least the limitations described above there is a need for an animated character conversation generator.

### BRIEF SUMMARY OF THE INVENTION

One or more embodiments described in the specification are related to an animated character conversation generator. Embodiments of the invention generally include a computer such as a tablet computer or any other type of computer having a display, an input device, a memory and a computer processor coupled with the display, input device and memory. Embodiments of the computer are generally configured to accept an input that selects a first and second predefined animated character, and accept at least one first expression for the first predefined animated character that includes at least one first computer animated video pre-rendered by a remote computer. Embodiments may also accept at least one first starting time for the at least one first expression and accept at least one first audio recording for the first predefined animated character. This for example enables a short animated building block video to be augmented with sound to begin an animated character conversation. Embodiments may also accept at least one second expression for the second predefined animated character that includes at least one second computer animated video pre-rendered by the remote computer, accept at least one second starting time for the at least one second expression and accept at least one second audio recording for the second predefined animated character, for example to continue building the animated conversation. The various audio and video are associated with one another, for example in time to generate the movie. For example, in one or more embodiments, the computer is configured to associate the at least one first computer animated video at the at least one first starting time of the at least one first expression with the at least one first audio recording for the first predefined animated character with the at least one second computer animated video at the at least one second starting time of the at least one second expression with the at least one second audio recording for the second predefined animated character to generate an animated character conversation movie.

In one or more embodiments the computer is further configured to receive and store animated character videos that represent celebrities, politicians or famous persons that display expressions in short videos wherein the animated character videos are pre-rendered by a second computer, which may be the remote computer or a local computer or any other computer connected or otherwise coupled over a communications medium to the computer.

At least one embodiment of the computer is further configured to accept a video editing input and set a video start time or video end time or both, optionally through acceptance of a mouse or finger drag or click. On tablet computers, dragging a finger across the display, or holding the finger on a timeline for example enables rapid modification of input values, however embodiments of the invention are not limited to any particular type of input and may utilize voice commands or motion gestures, e.g., up/down for yes/no on mobile devices with motion sensing capabilities for example. At least one embodiment of the computer is further configured to accept an audio editing input and set an audio start time or audio end time or both, optionally through acceptance of a mouse or finger drag or click.

At least one embodiment of the computer is further configured to accept audio pitch shifting input and alter audio frequency of the at least one first audio recording or the at least one second audio recording. This enables lower pitch input voices to be shifted to higher pitch audio in order to provide input to an animated character that would normally be associated with a different pitch than the user's input pitch.

At least one embodiment of the computer is further configured to combine the at least one first computer animated video with the at least one second computer animated video to create a combined video file, or combine the at least one first audio recording with the at least one second audio recording to create a combined audio file, or combine the at least one first computer animated video with the at least one second computer animated video and with the at least one first audio recording and with the at least one second audio recording to create a combined multimedia file.

At least one embodiment of the computer is further configured to accept an expression input associated with talking, angriness, craziness, crying, curious, disappointment, thinking, excitement, happiness, sadness, thinking, thumbs down, thumbs up. Any other type of expression is in keeping with the spirit of the invention and enables a wide range of animation to simulate a conversation between to characters.

At least one embodiment of the computer is further configured to automatically accept a language input to set a display language for display of information on the display or automatically set a language for display of information on the display based a location of the computer.

At least one embodiment of the computer is further configured to play the animated character conversation movie on the display. This is typically used during the editing process to view the animated video before sharing the video. In one or more embodiments, the computer is further configured to accept a video sharing destination input and transfer the animated character conversation movie to a remote server. This enables rapid creation and distribution of animated video of an animated character conversation for example without requiring modeling, ray tracing or complex tools.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an architectural view of at least one embodiment of the animated character conversation generator as shown executing on a tablet computer.

FIG. 2 illustrates an interface for accepting a language for the apparatus and/or software, as well as an interface for accepting a request to alter the selected animated characters.

FIG. 3 illustrates an interface that displays available, predefined animated characters as a picture or video of each character.

FIG. 4 illustrates an interface for accepting a full screen preview input as well as an interface for accepting expressions for each character along a timeline, for example predefined video animations of each character moving, gesturing, talking, hand waving, etc., along with an interface for accepting audio for each character along a timeline.

FIG. 4A illustrates an interface for accepting a full screen preview input as well as an interface for accepting expressions for each character along a timeline, for example predefined video animations of each character moving, gesturing, talking, hand waving, etc., along with a combined audio interface for accepting audio for each character along a single timeline.

FIG. 5 illustrates an interface for accepting a video sharing input as well as an interface for viewing and editing expressions for each character along a timeline, for example predefined video animations of each character moving, gesturing, talking, hand waving, etc., as well as the timing thereof, along with an interface for listening to and editing audio for each character along a timeline.

FIG. 5A illustrates an interface for accepting a video sharing input as well as an interface for viewing and editing expressions for each character along a timeline, for example predefined video animations of each character moving, gesturing, talking, hand waving, etc., as well as the timing thereof, along with an interface for listening to and editing audio for each character along a single timeline.

FIG. 6 illustrates an interface for editing a start and stop time for audio associated with a given character.

FIG. 7 illustrates an interface for the initial phase of creating a computer-animated video without modeling or rendering any characters by accepting an expression for a character wherein the expression is a pre-generated animated video of the character moving in some way for a particular length of time.

FIG. 8 illustrates an interface that displays and accepts available, predefined expressions for the selected character associated with a particular timeline. The expressions may be shown for example as videos of each character on mouse-over or simultaneously or in any other manner.

FIG. 9 illustrates an interface that accepts audio for the selected character associated with a particular timeline as well as an interface to accept pitch change for existing audio.

FIG. 10 illustrates a display of a video expression timeline and an audio timeline after the apparatus has accepted an expression and audio. The video and audio may be looped or played and the apparatus may display the current time of play.

FIG. 11 illustrates a display of a video expression timeline and an audio timeline after several inputs of expressions and audio have been accepted in order to create a conversation between two animated characters without modeling or ray tracing.

FIG. 12 illustrates the animation or movement of a character over time for a given selected expression.

FIG. 13 illustrates an interface to accept an input for the apparatus to output the generated video using a particular video sharing option.

### DETAILED DESCRIPTION OF THE INVENTION

An animated character conversation generator will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

FIG. 1 illustrates an architectural view of at least one embodiment of the animated character conversation generator 100 as shown executing on a computer such as tablet computer 101 that generally includes a display 102, which in this case also serves as an input device, a memory and a computer processor, both of which are located behind the display 102 and are coupled with the display, input device and memory. Computer 101 may wirelessly communicate with the Internet as shown for example to share or store generated movies on a website, which generally includes database “DB” as shown. As shown on display 102, the conversation may be displayed when complete in a virtual studio, in this exemplary scenario a studio known as “Gulf Talk”, that is rendered by a remote or other computer, in which animated characters converse with one another as instructed using embodiments of the invention.

FIG. 2 illustrates an interface 200 for accepting a language for the apparatus and/or software. Any number of languages may be utilized for interfacing with the apparatus and may be automatically selected based on location or via audio analysis. In addition, FIG. 2 shows interface 201 and interface 202 for accepting a request to alter the selected animated characters 211 and 212, for example in this scenario a Host and a Guest for the conversation. In one or more embodiments the computer is further configured to receive and store animated character videos that represent celebrities, politicians or famous persons that display expressions in short videos wherein the animated character videos are pre-rendered by a second computer, which may be the remote computer or a local computer or any other computer connected or otherwise coupled over a communications medium to the computer. Any other types of animated characters, animals, or other objects may be received, stored and utilized by embodiments of the invention.

FIG. 3 illustrates an interface that displays available, predefined animated characters 211, 212 as previously shown in FIGS. 1 and 2 along with predefined animated characters 313, 314, 315 which has not been paid for yet, and 316, as a picture or video of each character. Embodiments of the invention may accept payment for example via Internet or database DB or any computer coupled therewith as shown in FIG. 1. One or more embodiments of the interface may show character 212, which is currently selected as shown with a highlight around the character, in motion. Other embodiments may show all of the characters in motion or accept an input such as a mouse or finger click to show a character in motion.

FIG. 4 illustrates an interface 405 for accepting a full screen preview input (as shown in FIG. 1), as well as an interface 401 for accepting expressions for each character along a timeline, for example predefined video animations of each character moving, gesturing, talking, hand waving, etc., (see FIG. 3 for a partial list), along with an interface 403 for accepting audio for each character along a timeline. Video and audio events may be deleted after the apparatus detects input 402 or 404 respectively. As shown the Host and Guest animated characters have their own video and audio timelines respectively. FIG. 4A illustrates an interface for accepting a full screen preview input as well as an interface for accepting expressions for each character along a timeline, along with a combined audio interface for accepting audio recording commands for each character via inputs 403a and 403b along a single timeline.

FIG. 5 illustrates an interface 505 for accepting a video sharing input as well as interfaces 501 and 503 for viewing and editing expressions for each character along a timeline, for example the timing where the expressions occur, along with interface 502 and 504 for listening to and editing audio for each character along a timeline, including the start/stop and duration values for the audio. FIG. 5A further illustrates interfaces 502 and 504 for listening to and editing audio for each character along a single timeline.

FIG. 6 illustrates an interface for editing a start and stop time for audio associated with a given character. As shown, the start and stop time may be set with input elements 601 and 602. This enables synchronization of input audio with a predefined animated character to rapidly produce a conversation.

At least one embodiment of the computer is further configured to accept a video editing input and set a video start time or video end time or both, optionally through acceptance of a mouse or finger drag or click. On tablet computers, dragging a finger across the display, or holding the finger on a timeline for example enables rapid modification of input values, however embodiments of the invention are not limited to any particular type of input and may utilize voice commands or motion gestures, e.g., up/down for yes/no on mobile devices with motion sensing capabilities for example. At least one embodiment of the computer is further configured to accept an audio editing input and set an audio start time or audio end time or both, optionally through acceptance of a mouse or finger drag or click.

FIG. 7 illustrates an interface for the initial phase of creating a computer-animated video without modeling or rendering any characters by accepting an expression for a character wherein the expression is a pre-generated animated video of the character moving in some way for a particular length of time. The computer may initially accept an input that selects a first and second predefined animated character or alter the selection of characters at a later time wherein initial default characters may be provided to start with.

FIG. 8 illustrates an interface that displays and accepts available, predefined expressions for the selected character associated with a particular timeline. The computer may accept at least one first expression 801 for the first predefined animated character that includes at least one first computer animated video pre-rendered by a remote computer, for example which may couple to the computer via the Internet as shown in FIG. 1 or locally, which is not shown for brevity. The expressions 801, 802, 803, 804, 805 and 806 may be shown for example as videos of each character on mouse-over or simultaneously or in any other manner. The expression may include or otherwise be associated with talking, angriness, craziness, crying, curious, disappointment, thinking, excitement, happiness, sadness, thinking, thumbs down, thumbs up. Any other type of expression is in keeping with the spirit of the invention and enables a wide range of animation to simulate a conversation between to characters.

FIG. 9 illustrates an interface 901 that accepts and stops audio recording for the selected character associated with a particular timeline as well as an interface 902 to accept pitch change for existing audio. Once audio is recorded, embodiments may also accept at least one first starting time for the at least one first expression and accept at least one first audio recording for the first predefined animated character, which may be edited according to FIG. 6. This for example enables a short animated building block video to be augmented with sound to begin an animated character conversation. Embodiments may also accept at least one second expression for the second predefined animated character that includes at least one second computer animated video pre-rendered by the remote computer, accept at least one second starting time for the at least one second expression and accept at least one second audio recording for the second predefined animated character, for example to continue building the animated conversation.

FIG. 10 illustrates a display of a video expression timeline and an audio timeline after the apparatus has accepted an expression and audio. The video and audio may be looped or played and the apparatus may display the current time of play 1001.

FIG. 11 illustrates a display of a video expression timeline and an audio timeline after several inputs of expressions 1101, 1102 and 1103 and audio have been accepted in order to create a conversation between two animated characters without modeling or ray tracing.

FIG. 12 illustrates the animation or movement of a character 211 over time, e.g., at times 1001a, 1001 b and 1001c for a given selected expression showing sub-expressions 1101a, 1101b and 1101c respectively.

FIG. 13 illustrates an interface 1301 to accept an input for the apparatus to output the generated video using a particular video sharing option. Any video sharing, file sharing or social media website may be interfaced with in one or more embodiments of the invention, for example by storing a username and password on the apparatus for the particular site and transferring the movie to the site over http, or any other protocol for remote storage on database DB shown in FIG. 1.

At least one embodiment of the computer is further configured to combine the at least one first computer animated video with the at least one second computer animated video to create a combined video file for example to store in database DB shown in FIG. 1, or combine the at least one first audio recording with the at least one second audio recording to create a combined audio file, or combine the at least one first computer animated video with the at least one second computer animated video and with the at least one first audio recording and with the at least one second audio recording to create a combined multimedia file. The various audio and video are associated with one another, for example in time to generate the movie. For example, in one or more embodiments, the computer processor is configured to associate the at least one first computer animated video at the at least one first starting time of the at least one first expression with the at least one first audio recording for the first predefined animated character with the at least one second computer animated video at the at least one second starting time of the at least one second expression with the at least one second audio recording for the second predefined animated character to generate an animated character conversation movie. Any format for any type of multimedia may be utilized in keeping with the spirit of the invention.

While the invention herein disclosed has been described by means of specific embodiments and applications thereof, numerous modifications and variations could be made thereto by those skilled in the art without departing from the scope of the invention set forth in the claims.

What is claimed is:

1. An animated character conversation generator comprising:
a computer comprising
a display;
an input device;
a memory;
a computer processor coupled with the display, input device and memory wherein the computer is configured to
accept an input that selects a first predefined animated character;
accept an input that selects a second predefined animated character;
accept at least one first expression for the first predefined animated character comprising at least one first computer animated video pre-rendered by a remote computer;
accept at least one first starting time for the at least one first expression;
accept at least one first audio recording for the first predefined animated character;
accept at least one second expression for the second predefined animated character comprising at least one second computer animated video pre-rendered by the remote computer;
accept at least one second starting time for the at least one second expression;
accept at least one second audio recording for the second predefined animated character; and,
associate the at least one first computer animated video at the at least one first starting time of the at least one first expression with the at least one first audio recording for the first predefined animated character with the at least one second computer animated video at the at least one second starting time of the at least one second expression with the at least one second audio recording for the second predefined animated character to generate an animated character conversation movie.

2. The animated character conversation generator of claim 1, wherein the computer is further configured to receive and store animated character videos that represent celebrities, politicians or famous persons that display expressions in short videos wherein the animated character videos are pre-rendered by a second computer.

3. The animated character conversation generator of claim 1, wherein the computer is further configured to accept a video editing input and set a video start time or video end time or both.

4. The animated character conversation generator of claim 1, wherein the computer is further configured to accept a video editing input and set a video start time or video end time or both through acceptance of a mouse or finger drag or click.

5. The animated character conversation generator of claim 1, wherein the computer is further configured to accept an audio editing input and set an audio start time or audio end time or both.

6. The animated character conversation generator of claim 1, wherein the computer is further configured to accept an audio editing input and set an audio start time or audio end time or both through acceptance of a mouse or finger drag or click.

7. The animated character conversation generator of claim 1, wherein the computer is further configured to accept audio pitch shifting input and alter audio frequency of the at least one first audio recording or the at least one second audio recording.

8. The animated character conversation generator of claim 1, wherein the computer is further configured to combine the at least one first computer animated video with the at least one second computer animated video to create a combined video file.

9. The animated character conversation generator of claim 1, wherein the computer is further configured to combine the at least one first audio recording with the at least one second audio recording to create a combined audio file.

10. The animated character conversation generator of claim 1, wherein the computer is further configured to combine the at least one first computer animated video with the at least one second computer animated video and with the at least one first audio recording and with the at least one second audio recording to create a combined multimedia file.

11. The animated character conversation generator of claim 1, wherein the computer is further configured to accept an expression input associated with talking, angriness, craziness, crying, curious, disappointment, thinking, excitement, happiness, sadness, thinking, thumbs down, thumbs up.

12. The animated character conversation generator of claim 1, wherein the computer is further configured to automatically accept a language input to set a display language for display of information on the display.

13. The animated character conversation generator of claim 1, wherein the computer is further configured to automatically set a language for display of information on the display based a location of the computer.

14. The animated character conversation generator of claim 1, wherein the computer is further configured to play the animated character conversation movie on the display.

15. The animated character conversation generator of claim 1, wherein the computer is further configured to accept a video sharing destination input and transfer the animated character conversation movie to a remote server.

16. An animated character conversation generator comprising:
a computer comprising
a display;
an input device;
a memory;
a computer processor coupled with the display, input device and memory wherein the computer is configured to
receive and store animated character videos that represent celebrities, politicians or famous persons that display expressions in short videos wherein the animated character videos are pre-rendered by a remote computer;
accept an input that selects a first predefined animated character;
accept an input that selects a second predefined animated character;
accept at least one first expression for the first predefined animated character comprising at least one first computer animated video pre-rendered by the remote computer;
accept at least one first starting time for the at least one first expression;
accept at least one first audio recording for the first predefined animated character;
accept at least one second expression for the second predefined animated character comprising at least one second computer animated video pre-rendered by the remote computer;
accept at least one second starting time for the at least one second expression;
accept at least one second audio recording for the second predefined animated character; and,
associate the at least one first computer animated video at the at least one first starting time of the at least one first expression with the at least one first audio recording for the first predefined animated character with the at least one second computer animated video at the at least one second starting time of the at least one second expression with the at least one second audio recording for the second predefined animated character to generate an animated character conversation movie;
play the animated character conversation movie on the display; and,
accept a video sharing destination input and transfer the animated character conversation movie to a remote server.

17. The animated character conversation generator of claim 16, wherein the computer is further configured to accept audio pitch shifting input and alter audio frequency of the at least one first audio recording or the at least one second audio recording.

18. The animated character conversation generator of claim 16, wherein the computer is further configured to combine the at least one first computer animated video with the at least one second computer animated video and with the at least one first audio recording and with the at least one second audio recording to create a combined multimedia file.

19. The animated character conversation generator of claim 16, wherein the computer is further configured to accept an expression input associated with talking, angriness, craziness, crying, curious, disappointment, thinking, excitement, happiness, sadness, thinking, thumbs down or thumbs up.

20. An animated character conversation generator comprising:
a computer comprising
a display;
an input device;
a memory;
a computer processor coupled with the display, input device and memory wherein the computer is configured to
receive and store animated character videos that represent celebrities, politicians or famous persons that display expressions in short videos wherein the animated character videos are pre-rendered by a remote computer;
accept an input that selects a first predefined animated character;
accept an input that selects a second predefined animated character;
accept at least one first expression for the first predefined animated character comprising at least one first computer animated video pre-rendered by the remote computer wherein the expression comprises talking, angriness, craziness, crying, curious, disappointment, thinking, excitement, happiness, sadness, thinking, thumbs down or thumbs up;
accept at least one first starting time for the at least one first expression;
accept at least one first audio recording for the first predefined animated character;
accept at least one second expression for the second predefined animated character comprising at least one second computer animated video pre-rendered by the remote computer;
accept at least one second starting time for the at least one second expression;
accept at least one second audio recording for the second predefined animated character; and,
associate the at least one first computer animated video at the at least one first starting time of the at least one first expression with the at least one first audio recording for the first predefined animated character with the at least one second computer animated video at the at least one second starting time of the at least one second expression with the at least one second audio recording for the second predefined animated character to generate an animated character conversation movie;
play the animated character conversation movie on the display; and,
accept a video sharing destination input and transfer the animated character conversation movie to a remote server.
